(19) United States
(12) Patent Application Publication
(10) Pub. No.: US 2006/0292409 A1
(43) Pub. Date: Dec. 28, 2006

(54) Fuel reforming system and fuel cell system including the same

(75) Inventors: In Hyuk Son, Yongin (KR); Sang Jun Kong, Yongin (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/376,327

(22) Filed: Mar. 16, 2006

(30) Foreign Application Priority Data
Jun. 24, 2005 (KR) 2005-55292

(51) Int. Cl. H01M 8/06; B01J 19/00; B01J 35/02

(52) U.S. Cl. 429/20; 422/198; 422/211

(57) ABSTRACT

A fuel reforming system includes a plate type preferential CO oxidation unit, which removes CO from a hydrogen rich gas generated by a heat cracking unit. The plate type preferential CO oxidation unit mixes the hydrogen rich gas with oxygen and cools the hydrogen rich gas to an activating temperature of a CO removing catalyst.

### CROSS REFERENCE TO RELATED APPLICATION

This application claims priority to and the benefit of Korean Patent Application No. 10-2005-0055292, filed on Jun. 24, 2005, which is hereby incorporated by reference for all purposes as if fully set forth herein.

### BACKGROUND

1. Field of the Invention

The present invention relates to a fuel reforming system and a fuel cell system including the same, and more particularly, to a fuel reforming system that includes a gas mixing and cooling system and a fuel cell system including the same.

2. Discussion of the Background

In general, fuel cell systems generate electric energy through an electrochemical reaction between hydrogen and oxygen. Fuel cell systems have been researched and developed as an alternative power source to meet an increased demand for power and to solve environmental problems.

Fuel cell systems may be classified according to the type of electrolyte used, such as a phosphoric acid fuel cell (PAFC), a molten carbon fuel cell (MCFC), a solid oxide fuel cell (SOFC), a polymer electrolyte membrane fuel cell (PEMFC), or an alkaline fuel cell (AFC). Fuel cell systems may be applied to various applications, such as mobile devices, transportation, and distributed power sources, depending on various factors, such as the type of fuel used, the driving temperature, and the output range.

Compared with other fuel cells, PEMFCs are especially advantageous because they have good output capability, operate at low temperatures, may be started quickly, have a fast response time, and may be applied to a wide range of fields. A fuel reforming system to provide hydrogen has been developed for the PEMFC. The fuel reforming system may employ various hydrogen containing fuels to produce and supply the hydrogen necessary for driving a fuel cell stack. To enhance efficiency, a fuel reforming system should be small and lightweight, start quickly, have a fast dynamic response time, and have a low production cost.

Conventional fuel reforming systems have been disclosed in Japanese laid-open patent application No. 2004-10376, Japanese laid-open patent application No. 2000-95506, Korean laid-open patent application No. 2000-5385, and Japanese laid-open patent application No. 2004-26526.

Japanese laid-open patent No. 2004-10376 discloses a CO removing unit mounted with a plate type heat pipe. This fuel reforming system distributes heat from a selective oxidation reaction by evaporating and condensing a fluid in the heat pipe while hydrogen rich gas flows through a plate type pin.

Japanese laid-open patent No. 2000-95506 discloses a CO selective oxidation reaction container including a CO oxidation catalyst. The CO selective oxidation reaction container externally contacts a liquid heat medium, which is vaporized to make the temperature of the catalyst uniform.

Korean patent laid-open No. 2000-5385 discloses a natural gas reformer shaped like a plate, which includes a heat conductive plate stack scattered with a catalyst plate, and an internal or external branched pipe for a reactant.

Japanese patent laid-open No. 2004-26526 discloses a reforming reaction device in which a channel plate, a header plate and an intermediate plate are stacked, and source and fuel gas are supplied or discharged through a through hole formed on the plates.

However, the foregoing conventional fuel reforming systems lack a structure for decreasing the temperature of hydrogen rich gas introduced from a reformer to an activating temperature of a CO oxidation catalyst provided in a CO removing unit.

Therefore, in conventional fuel reforming systems, the temperature of hydrogen rich gas may not be reduced to the activating temperature of the CO oxidation catalyst in the CO removing unit. This may prevent the CO oxidation catalyst from effectively decreasing the CO gas contained in the hydrogen rich gas, which may decrease the durability of the fuel cell.

Further, in the foregoing conventional fuel cell systems, the hydrogen rich gas and oxygen introduced into the CO removing unit may not be effectively mixed, so that the CO removing efficiency of the CO removing unit is relatively low. Therefore, a structure is needed to uniformly mix the hydrogen rich gas and oxygen in the CO removing unit.

### SUMMARY OF THE INVENTION

The present invention provides a fuel reforming system and a fuel cell system including the same, in which a preferential CO oxidation unit may reduce the amount of CO gas in a hydrogen rich gas by lowering the temperature of the hydrogen rich gas to the activating temperature of a CO oxidation catalyst and oxidizing the CO using the CO oxidation catalyst.

The present invention also provides a fuel reforming system and a fuel cell system including the same, which includes a preferential CO oxidation unit for uniformly mixing hydrogen rich gas with oxygen.

Additional features of the invention will be set forth in the description which follows, and in part will be apparent from the description, or may be learned by practice of the invention.

The present invention discloses a fuel reforming system, including a plate type preferential CO oxidation unit including an inlet plate including a passage through which gas including hydrogen may pass; and a reaction plate communicating with the inlet plate so that fluid may be transferred between the reaction plate and the inlet plate, the reaction plate including a CO oxidation catalyst.

The present invention also discloses a fuel cell system, including a fuel feeder to supply a hydrogen containing fuel; a fuel reforming system including a reforming unit to reform the hydrogen containing fuel into gas mainly including hydrogen, and a CO removing unit to remove CO from the hydrogen rich gas; and a stack to generate electricity by oxidizing the hydrogen rich gas, wherein the reforming unit includes a heat cracking unit to generate gas mainly including hydrogen by reforming the hydrogen containing fuel; and wherein the CO removing unit includes a plate type preferential CO oxidation unit including an inlet plate including a passage through which the hydrogen rich gas may pass; and a reaction plate communicating with the inlet plate so that fluid may be transferred between the reaction plate and the inlet plate, the reaction plate including a CO oxidation catalyst.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which arc included to provide a further understanding of the invention and are incorporated in and constitute a part of this specification, illustrate embodiments of the invention, and together with the description serve to explain the invention.

FIG. 1 is a block diagram of a fuel cell system including a fuel reforming system according to an exemplary embodiment of the present invention.

FIG. 2 is a block diagram of a fuel reforming system according to an exemplary embodiment of the present invention.

FIG. 3 is an exploded perspective view of a preferential CO oxidation unit provided in the fuel reforming system according to an exemplary embodiment of the present invention.

FIG. 4 is a perspective view of a reaction plate, which may be used in the preferential CO oxidation unit of FIG. 3.

FIG. 5 is an exploded perspective view of a preferential CO oxidation unit provided in a fuel reforming system according to an exemplary embodiment of the present invention.

FIG. 6 is a perspective view of an inlet plate, which may be used for the preferential CO oxidation unit of FIG. 3d.

FIG. 7 is a perspective view of a plate, which may be used for the preferential CO oxidation unit of FIG. 3.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

A hydrogen containing fuel may include an alcoholic fuel, such as methanol or ethanol, a hydro-carbonaceous fuel, such as methane, propane, or butane, or a natural gas fuel such as liquefied natural gas. The hydrogen containing fuel may be a mixed fuel, such as a fuel mixed with water. The fuel cell system may generate electric energy by the electrochemical reaction of oxygen and hydrogen gas produced by reforming the hydrogen containing fuel. The fuel cell may be a polymer electrolyte membrane fuel cell (PEMFC), or another type of fuel cell.

Referring to FIG. 1, a fuel cell system may include a fuel feeder 10 to supply a hydrogen containing fuel, a fuel reforming system 20 to generate hydrogen by reforming the hydrogen containing fuel, and a stack 30 to generate electricity by an electrochemical reaction between hydrogen and oxygen. An air feeder 40 may supply an oxidizing agent such as oxygen in air to the stack 30. The air feeder 40 may also supply the oxidizing agent to a heat source such as a combustor used to supply energy to the fuel reforming system 20, as well as to the fuel reforming system 20 itself.

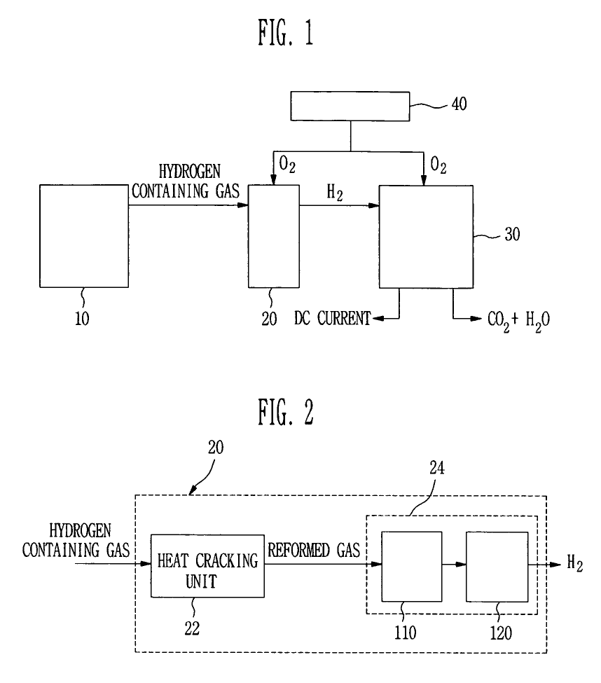

As shown in FIG. 2, the fuel reforming system 20 may include a heat cracking unit 22 connected with the fuel feeder 10 so that fluid may be transferred between the heat cracking unit 22 and the fuel feeder 10, and a CO removing unit 24 connected with the stack 30 so that fluid may be transferred between the CO removing unit 24 and the stack 30. The heat cracking unit 22 and the CO removing unit 24 may also be connected with each other so that fluid may be transferred between the heat cracking unit 22 and the CO removing unit 24.

A hydrogen containing fuel may be fed to the heat cracking unit 22 by the fuel feeder 10. The heat cracking unit 22 may reform the hydrogen containing fuel by a method such as thermal cracking to generate a hydrogen rich gas. The CO removing unit 24 may remove CO from the hydrogen rich gas supplied from the heat cracking unit 22. The CO removing unit 24 may reduce the amount of CO in the hydrogen rich gas to less than about 50 ppm, and preferably, to less than about 10 ppm. High purity hydrogen may then be sent to the stack 30.

The stack 30 may include a plurality of unit cells, each of which may include a membrane electrode assembly (MEA) including a polymer membrane, and a cathode and an anode arranged on opposite sides of the polymer membrane. Hydrogen may be supplied from the CO removing unit 24 of the fuel reforming system 20 to the anode of the stack 30, and oxygen in air may be supplied to the cathode of the stack 30. The electricity generated by the electrochemical reaction between the hydrogen and oxygen may flow through a current collector to an external circuit. CO₂ and water may be created as byproducts of the electrochemical reaction. CO₂ may be discharged to the atmosphere, and water may be recycled or discharged.

The heat cracking unit 22 may reform the hydrogen containing fuel by a method such as steam reforming (SR), auto-thermal reforming (ATR), or partial oxidation (POX). The POX method and the ATR method may be started quickly and have an excellent response to load variation, while the SR method has excellent hydrogen generation efficiency.

The SR method reforms a hydrogen containing fuel using an endothermic chemical reaction between the hydrogen containing fuel and steam on a catalyst. The SR method requires a relatively large amount of energy from an outside source to perform the endothermic reaction, but is widely used because the method stably produces hydrogen gas at a relatively high concentration.

The ATR method does not require an external heat source because the hydrogen containing fuel may be reformed using an endothermic steam reforming reaction and an exothermic oxidation reaction. The POX method reforms a hydrogen containing fuel by an exothermic chemical reaction between the hydrogen containing fuel and oxygen on a catalyst, and does not require an external heat source.

Referring to FIG. 1 and FIG. 2, if the heat cracking unit 22 employs the SR method, the fuel reforming system 20 may employ a combustor to supply the required energy to the heat cracking unit 22 to power the endothermic reaction. The combustor may receive the hydrogen containing fuel, such as methanol, from the fuel feeder 10, and may receive oxygen in air from the air feeder 40. The hydrogen containing fuel and oxygen in air are burned in the combustion reaction shown in formula (1). The energy produced by the combustion reaction may be supplied to the heat cracking unit 22.
CH₃OH(g)+1.5O₂⇄2H₂O(g)+CO₂ (1)

When the heat cracking unit 22 employs the SR method, water may be supplied from a water tank to the heat cracking unit 22 through the hydrogen containing fuel supply line or through a separate supply line to obtain the steam needed for the SR method. The heat cracking unit 22 may use a reforming catalyst, such as a nickel catalyst, a ruthenium catalyst, or a rhodium catalyst, to activate the reforming reaction. The reforming catalyst may be preheated by the combustor to an activating temperature so that the hydrogen containing fuel, such as methanol, and steam supplied to the heat cracking unit 22 produces hydrogen gas according to the reforming reaction of formula (2) and formula (3).
CH₃OH(g)+H₂O(g)⇄CO₂+3H₂ (2)
CH₃OH(l)+H₂O(l)⇄CO₂+3H₂ (3)

The reforming reaction of the heat cracking unit 22 may be accompanied by the reaction of formula (4), so that the heat cracking unit 22 also generates CO gas.
CO₃OH⇄CO+2H₂ (4)

It is desirable to remove CO from the hydrogen rich gas because CO may poison the catalyst provided in the stack 30, which may shorten the life span of the fuel cell. The CO removing unit 24 may remove CO from the hydrogen rich gas to reduce the amount of CO to less than about 50 ppm, and preferably, to less than about 10 ppm. The high purity hydrogen gas may then be supplied to the stack 30.

The CO removing unit 24 may include a water gas shift (WGS) unit 110 and/or a preferential CO oxidation (PROX) unit 120. The WGS unit 110 and the PROX unit 120 may be connected with each other so that fluid may be transferred between the WGS unit 110 and the PROX unit 120.

The WGS unit 110 may be provided with a shift catalyst, such as a copper-zinc catalyst to facilitate a water gas shift reaction. The concentration of CO in the hydrogen rich gas may be decreased on the shift catalyst of the WGS unit 110 by a chemical reaction with steam as shown in formula (5). The hydrogen rich gas may then be supplied to the PROX unit 120.
CO+H₂O⇄CO₂+H₂ (5)

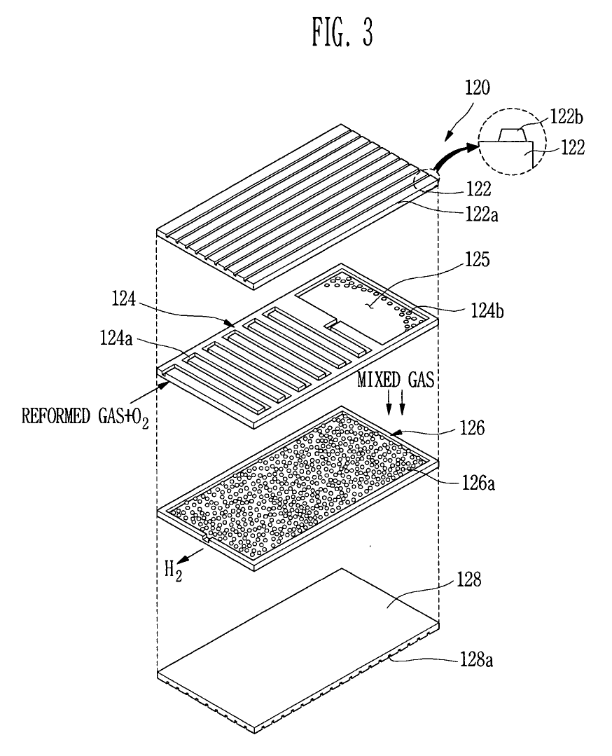

Referring to FIG. 3, the PROX unit 120 may be a plate type PROX unit 120 and may include an inlet plate 124 formed with a channel 124a for the hydrogen rich gas, and a reaction plate 126 connected to the inlet plate 124, so that the hydrogen rich gas may flow from the inlet plate 124 to the reaction plate 126.

The inlet plate 124 may include a channel portion that includes a channel 124a, which forms a passage through which the hydrogen rich gas may flow. Hydrogen rich gas may be introduced to an inlet of the inlet plate 124 from the heat cracking unit 22 via the WGS unit 110. Oxygen may be also be introduced to the inlet of the inlet plate 124, to oxidize CO at the reaction plate 126. The hydrogen rich gas and the oxygen may be uniformly mixed in the channel 124a of the inlet plate 124.

The inlet plate 124 may also include a distributor 125 that includes a plurality of holes 124b. The outlet of the channel 124a may be connected with the distributor 125. The holes 124b may be arranged at an approximately equal distance from the outlet of the channel portion to uniformly supply the hydrogen containing fuel to the reaction plate 126.

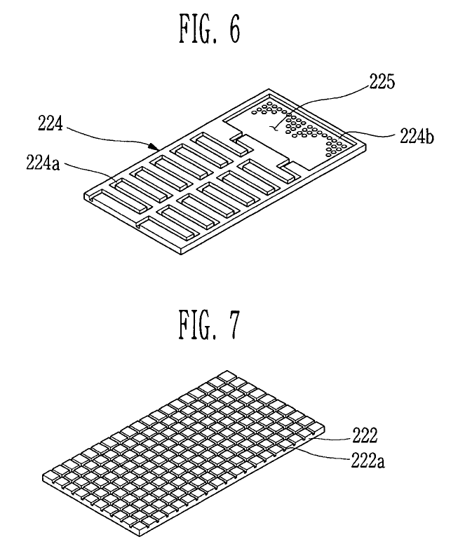

Referring to FIG. 6, the channel portion of the inlet plate 224 may include two channels 224a and their corresponding inlets and outlets to increase the amount of hydrogen containing gas and oxygen that may flow through the channel portion 224. The holes 224b formed in the distributor 225 of the inlet plate 224 may formed at an approximately equal distance from the respective outlets of the channels 224a.

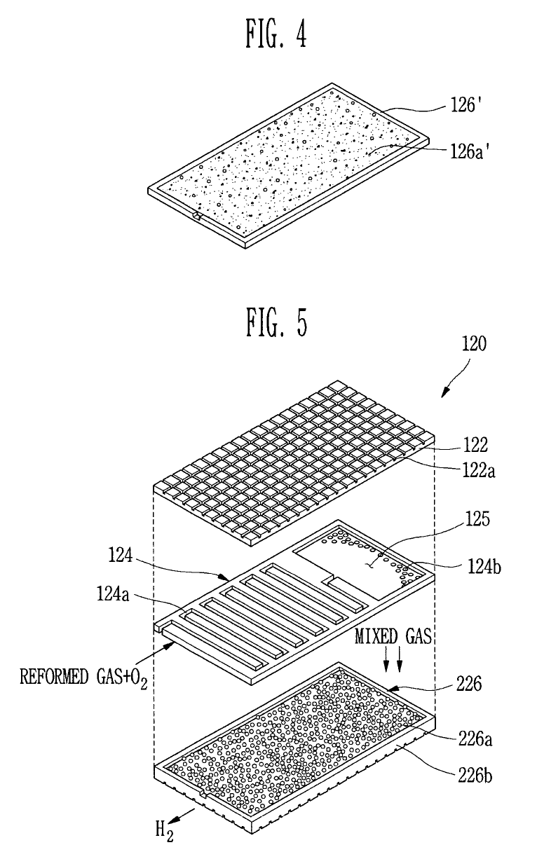

Referring to FIG. 3, the reaction plate 126 may be filled with a CO oxidation catalyst 126a to selectively oxidize CO contained in the mixed gas. The CO oxidation catalyst 126a may be a catalyst such as a platinum catalyst or a ruthenium catalyst, which may be provided as a granular catalyst or a porous catalyst. FIG. 3 shows a reaction plate 126 that includes a porous catalyst 126a. FIG. 4 shows a reaction plate 126′ that includes a granular catalyst 126a′. CO may be oxidized on the CO removing catalyst 126a of the reaction plate 126 by the oxidation reaction shown in formula (6).
CO+½O₂⇄CO₂ (6)

An upper plate 122 may be placed above the inlet plate 124, and a lower plate 128 may be placed below the reaction plate 126. The upper plate 122 may have a top external surface that includes a groove 122a and a flat bottom surface. The lower plate 128 may have a flat top surface, which contacts the bottom of the reaction plate 126, and a bottom external surface that includes a groove 128a. A refrigerant such as air or water may flow through the grooves 122a in the upper plate 122 and through the grooves 128a of the lower plate 128. The grooves 122a and 128a on the external surfaces of the upper plate 122 and the lower plate 128, respectively, may increase the heat exchange area of the plates.

The hydrogen containing fuel and the oxygen flowing through the channel 124a may exchange heat with the external refrigerant in the channels 122a of the upper plate 122. The temperature of the hydrogen containing fuel may thus be lowered to a temperature suitable for activating a CO removing catalyst provided in the reaction plate 126. Heat generated by the selective oxidation reaction of the CO in the reaction plate 126 may be radiated through the lower plate 128.

The upper plate 122 and the lower plate 128 may further include heat radiation fins 122b on their respective outer surfaces to enhance the efficiency of a heat exchange with air flowing along the grooves. Referring to FIG. 7, the heat radiation fins 122b may be formed on a plate 222 by forming the grooves 222a to intersect each other at a predetermined angle. The heat radiation fins 122b may include a sharp edge.

Referring to FIG. 5, the reaction plate 226 may be formed with a groove 226b on its outer surface. In this case, the lower plate 128, shown in FIG. 3 may be omitted to decrease the size of the preferential CO oxidation unit.

The operation of a fuel cell system according to an exemplary embodiment of the present invention will now be described with reference to FIG. 1.

Hydrogen containing fuel may be supplied from the fuel feeder 10 to the fuel reforming system 20. The hydrogen containing fuel may be reformed by the catalyst in the heat cracking unit 22 of the reformer 20 to generate hydrogen rich gas that contains mainly hydrogen. The hydrogen rich gas may be supplied to a WGS unit 110 where CO contained in the hydrogen rich gas may be removed by a water gas shift reaction based on activation of a shift catalyst.

The hydrogen rich gas and oxygen may then be supplied to the inlet plate 124 of the preferential CO oxidation unit 120. The hydrogen rich gas and oxygen may be mixed in the channel 124a the inlet plate 124, and then introduced into the reaction plate 126 through the holes 124b of the inlet plate 124. The heat exchange in the inlet plate 124 may cool the hydrogen rich gas to the activating temperature of the CO removing catalyst 126a.

CO may be removed from the hydrogen rich gas by the activation of the CO removing catalyst 126a. For example, the concentration of CO may be lowered by oxidizing CO in the preferential CO oxidation unit 120 to reduce the content of CO in the hydrogen rich gas to less than about 50 ppm, and preferably, to less than about 10 ppm. This process may generate a hydrogen gas with high purity.

The high purity hydrogen gas and air may be supplied to the anode and the cathode of the stack 30, respectively, to generate electricity. The electricity may flow through a current collector to an external circuit.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A fuel reforming system, comprising:
a plate type preferential CO oxidation unit comprising:
an inlet plate comprising a passage through which gas comprising hydrogen may pass; and
a reaction plate communicating with the inlet plate so that fluid may be transferred between the reaction plate and the inlet plate, the reaction plate comprising a CO oxidation catalyst.

2. The fuel reforming system of claim 1,
wherein the passage comprises a channel portion comprising a channel, and a distributor communicating with the channel so that fluid may be transferred between the channel and the distributor, and
wherein the distributor comprises holes communicating with the reaction plate so that fluid may be transferred between the distributor and the reaction plate.

3. The fuel reforming system of claim 1, further comprising:
an upper plate arranged above the inlet plate, the upper plate comprising a groove through which a refrigerant may flow, the groove being arranged on an outer surface of the upper plate.

4. The fuel reforming system of claim 3,
wherein the refrigerant comprises air.

5. The fuel reforming system of claim 3,
wherein the upper plate further comprises a heat radiation fin arranged on the outer surface.

6. The fuel reforming system of claim 5,
wherein the heat radiation fin comprises an intersection of a plurality of grooves.

7. The fuel reforming system of claim 1, further comprising:
a lower plate arranged below the reaction plate, the lower plate comprising a groove through which a refrigerant may flow, the groove being arranged on an outer surface of the lower plate.

8. The fuel reforming system of claim 7,
wherein the refrigerant comprises air.

9. The fuel reforming system of claim 7,
wherein the lower plate further comprises a heat radiation fin arranged on the outer surface.

10. The fuel reforming system of claim 9,
wherein the heat radiation fin comprises an intersection of a plurality of grooves.

11. The fuel reforming system of claim 1,
wherein the reaction plate comprises a groove through which a refrigerant may flow, the groove being arranged on an outer surface of the reaction plate.

12. The fuel reforming system of claim 11,
wherein the refrigerant comprises air.

13. The fuel reforming system of claim 11,
wherein the reaction plate further comprises a heat radiation fin arranged on the outer surface.

14. The fuel reforming system of claim 13,
wherein the heat radiation fin comprises an intersection of a plurality of grooves.

15. The fuel reforming system of claim 1,
wherein the CO oxidation catalyst comprises a platinum catalyst or a ruthenium catalyst.

16. The fuel reforming system of claim 1, further comprising:
a water gas shift unit; and
a heat cracking unit,
wherein the water gas shift unit is arranged between and communicates with the plate type preferential CO oxidation unit and the heat cracking unit, so that fluid may be transferred between the heat cracking unit, the water gas shift unit, and the plate type preferential CO oxidation unit.

17. The fuel reforming system of claim 1, further comprising:
a heat cracking unit that reforms a hydrogen containing fuel by a steam reforming (SR) method, an auto-thermal reforming (ATR) method, or a partial oxidation (POX) method.

18. The fuel reforming system of claim 2,
wherein the channel portion comprises a plurality of channels.

19. The fuel reforming system of claim 17,
wherein the hydrogen containing fuel comprises an alcoholic fuel, a hydro-carbonaceous fuel, or a natural gas fuel.

20. A fuel cell system, comprising:
a fuel feeder to supply a hydrogen containing fuel;
a fuel reforming system comprising:
a reforming unit to reform the hydrogen containing fuel into gas mainly comprising hydrogen, and
a CO removing unit to remove CO from the gas; and
a stack to generate electricity by oxidizing the gas,
wherein the reforming unit comprises a heat cracking unit to generate gas mainly comprising hydrogen by reforming the hydrogen containing fuel; and
wherein the CO removing unit comprises a plate type preferential CO oxidation unit comprising:
an inlet plate comprising a passage through which the gas may pass; and
a reaction plate communicating with the inlet plate so that fluid may be transferred between the reaction plate and the inlet plate, the reaction plate comprising a CO oxidation catalyst.

21. The fuel cell system of claim 20,
wherein the passage comprises a channel portion comprising a channel, and a distributor communicating with the channel so that fluid may be transferred between the channel and the distributor, and
wherein the distributor comprises holes communicating with the reaction plate so that fluid may be transferred between the distributor and the reaction plate.

22. The fuel cell system of claim 20, further comprising:
an upper plate arranged above the inlet plate, the upper plate comprising a groove through which a refrigerant may flow, the groove being arranged on an outer surface of the upper plate.

23. The fuel cell system of claim 22,
wherein the upper plate further comprises a heat radiation fin arranged on the outer surface.

24. The fuel cell system of claim 22,
wherein the heat radiation fin comprises an intersection of a plurality of grooves.

25. The fuel cell system of claim 20, further comprising:
a lower plate arranged below the reaction plate, the lower plate comprising a groove through which a refrigerant may flow, the groove being arranged on an outer surface of the lower plate.

26. The fuel cell system of claim 25,
wherein the lower plate further comprises a heat radiation fin arranged on the outer surface.

27. The fuel cell system of claim 26,
wherein the heat radiation fin comprises an intersection of a plurality of grooves.

28. The fuel cell system of claim 20,
wherein the reaction plate comprises a groove through which a refrigerant may flow, the groove being arranged on an outer surface of the reaction plate.

29. The fuel cell system of claim 28,
wherein the reaction plate further comprises a heat radiation fin arranged on the outer surface.

30. The fuel cell system of claim 29,
wherein the heat radiation fin comprises an intersection of a plurality of grooves.

31. The fuel cell system of claim 20,
wherein the CO oxidation catalyst comprises a platinum catalyst or a ruthenium catalyst.

32. The fuel cell system of claim 20,
wherein the CO removing unit further comprises a water gas shift unit arranged between and communicating with the heat cracking unit and the plate type preferential CO oxidation unit, so that fluid may be transferred between the heat cracking unit, the water gas shift unit, and the plate type preferential CO oxidation unit.

33. The fuel cell system of claim 20,
wherein the heat cracking unit reforms the hydrogen containing fuel by a steam reforming (SR) method, an auto-thermal reforming (ATR) method, or a partial oxidation (POX) method.

34. The fuel cell system of claim 20,
wherein the channel portion comprises a plurality of channels.

35. The fuel cell system of claim 20,
wherein the hydrogen containing fuel comprises an alcoholic fuel, a hydro-carbonaceous fuel, or a natural gas fuel.
